(19) United States
(12) Patent Application Publication
(10) Pub. No.: US 2002/0047711 A1
(43) Pub. Date: Apr. 25, 2002

(54) Method and apparatus for testing cells and batteries embedded in series/parallel systems

(76) Inventors: Kevin I. Bertness, Batavia, IL (US); Keith S. Champlin, Minneapolis, MN (US)

Correspondence Address: Judson K. Champlin, WESTMAN, CHAMPLIN & KELLY, P.A., Suite 1600 - International Centre, 900 Second Avenue South, Minneapolis, MN, 55402-3319, US

(21) Appl. No.: 09/862,783

(22) Filed: May 21, 2001

Related U.S. Application Data
(63) Continuation-in-part of application No. 09/662,092, filed on Sep. 14, 2000.

(51) Int. Cl. G01N 27/416

(52) U.S. Cl. 324/426

(57) ABSTRACT

A “three-point” measurement technique precisely determines dynamic electrical parameters of individual cells/batteries and/or interconnecting conductors embedded in a larger series, parallel, or series-parallel battery/electrical system. Three measuring points are defined. Two of these points comprise terminals of the subject cell/battery or interconnecting conductor. The third measuring point is an adjacent point that is separated from one of the other two measuring points by a single conducting path that may include one or more cells or batteries. By measuring dynamic parameters between alternate pairs of these three measuring points, three dynamic parameter measurements are acquired. A mathematical computation combines the three measurements and uniquely determines the desired dynamic parameters of one or two subject elements—thus effectively “de-embedding” the subject elements from the remainder of the system. A “four-point” extension of this technique permits measuring individual dynamic parameters of single cells/batteries disposed internally in a multiple-unit string of parallel-connected cells/batteries.

The present application is a Continuation-In-Part of and claims priority of U.S. patent application Ser. No. 09/662,092, filed Sep. 14, 2000, the content of which is hereby incorporated by reference in its entirety.

### BACKGROUND OF THE INVENTION

The present invention relates to electronically testing electrochemical cells and batteries. More specifically, it relates to precisely determining an individual dynamic parameter of a particular cell, battery, or interconnecting conductor that is embedded in a larger system of series, parallel, or series-parallel connected cells/batteries, loads, and chargers.

Electrochemical cells and batteries, such as primary cells/batteries, secondary (i.e., storage) cells/batteries, and fuel cells/batteries are important sources of electrical energy. Connecting such units together in series causes their voltages to add. Connecting them together in parallel causes their currents to add. Accordingly, series-connected cells/batteries, parallel-connected cells/batteries, and series/parallel combinations of cells/batteries are routinely found in many applications including automotive, traction, heavy equipment, standby, and telecommunication applications.

Precisely determining a dynamic electrical parameter (i.e., complex impedance, complex admittance, real resistance, or real conductance) of an individual cell/battery or interconnecting conductor embedded in a larger system without disconnecting the subject element from the system has traditionally posed an important challenge. One approach to this challenge has been described by Burkum et al. in U.S. Pat. No. 4,697,134. This patent teaches passing a known ac current through the parallel combination of a string of series-connected cells, a battery charger, and a load. It then determines the “impedance” of an individual cell or inter-cell connector by measuring the ac voltage developed across the cell or connector and taking the ratio of this measured ac voltage to the known ac current. However, this procedure determines only the magnitude of the complex impedance. Furthermore, the disclosed technique is subject to significant errors due to current-shunting by the charger and the load. The disclosed method also ignores the influence of other series strings in parallel with the desired string in a multi-string installation—such as would commonly be found in a telephone central office.

Methods and apparatus for measuring complex impedance and complex admittance of electrochemical cells and batteries as well as general electrical elements have recently been disclosed by Champlin in U.S. Pat. No. 6,002,238, U.S. Pat. No. 6,172,483, U.S. patent application Ser. No. 09/503,015 and U.S. patent application Ser. No. 09/710,031. However, the techniques disclosed therein apply generally to measuring isolated elements. If the subject element is embedded in a larger battery/electrical system, the loading imposed by the system could influence the results of the measurement.

The inventions disclosed herein, however, remove this system influence by mathematically de-embedding a subject “element”, i.e., cell, battery or interconnecting conductor, from the remainder of the battery/electrical system. The disclosed method and apparatus permit precisely determining a dynamic parameter of an embedded element without actually disconnecting the element from the battery/electrical system.

### SUMMARY OF THE INVENTION

The present invention employs a “three-point” measurement technique to precisely determine dynamic electrical parameters (i.e., complex impedance, complex admittance, real resistance, or real conductance) of individual elements (i.e., cells/batteries or interconnecting conductors) embedded in a larger series, parallel, or series-parallel battery/electrical system. The system may include a load and/or a battery charger. Three measuring points are defined. Two of these points comprise terminals of the subject cell/battery or interconnecting conductor. The third measuring point is an adjacent point that is separated from one of the other two measuring points by a single conducting path that may include one or more cells or batteries. By measuring dynamic parameters between alternate pairs of these three measuring points, three dynamic parameter measurements are acquired. A mathematical computation combines the three measurements and uniquely determines the desired dynamic parameters of one or two subject elements—thus effectively “de-embedding” the subject elements from the remainder of the system. A “four-point” extension of this technique permits measuring individual dynamic parameters of single cells/batteries disposed internally in a multiple-unit string of parallel-connected cells/batteries.

### BRIEF DESCRIPTION OF THE DRAWINGS

FIG. 1 is a schematic representation depicting the impedance of a cell/battery being measured while the cell/battery is connected to a load.

FIG. 2 is a simplified equivalent circuit representing the measurement arrangement of FIG. 1.

FIG. 3 is a schematic representation of a first impedance measurement of the circuit of FIG. 1 in accordance with a particular aspect of the present invention.

FIG. 4 is a schematic representation of a second impedance measurement of the circuit of FIG. 1 in accordance with a particular aspect of the present invention.

FIG. 5 is a schematic representation of a third impedance measurement of the circuit of FIG. 1 in accordance with a particular aspect of the present invention.

FIG. 6 is a simplified equivalent circuit of the circuit of FIG. 1 illustrating the three impedances measured in the measurements of FIGS. 3, 4, and 5.

FIG. 7 depicts measuring the impedance of a cell/battery embedded in a series string of such batteries with a plurality of series strings arrayed in parallel.

FIG. 8 is a schematic representation of a first impedance measurement of the circuit of FIG. 7 in accordance with a particular aspect of the present invention.

FIG. 9 is a schematic representation of a second impedance measurement of the circuit of FIG. 7 in accordance with a particular aspect of the present invention.

FIG. 10 is a schematic representation of a third impedance measurement of the circuit of FIG. 7 in accordance with a particular aspect of the present invention.

FIG. 11 depicts measuring the impedance of a cell/battery and/or interconnecting conductor embedded in the system of FIG. 7 using a special “three-point” impedance meter in accordance with a particular aspect of the present invention.

FIG. 12 is a block diagram representation of the special “three-point” impedance meter depicted in FIG. 11.

FIG. 13 is a block diagram representation of a special “n-point” impedance meter in accordance with a particular aspect of the present invention.

FIG. 14 is a flow chart of a control algorithm for de-embedding M single elements using the apparatus of FIG. 13.

FIG. 15 represents a part of a battery system and demonstrates general rules to be followed when choosing measuring points.

FIG. 16a is a schematic representation of two cells/batteries connected in parallel and depicts the determination of a first cell/battery impedance and a first interconnecting conductor impedance in accordance with a particular aspect of the present invention.

FIG. 16b is a schematic representation of two cells/batteries connected in parallel and depicts the determination of a second cell/battery impedance and a second interconnecting conductor impedance in accordance with a particular aspect of the present invention.

FIG. 17a is a schematic representation of a parallel string of multiple cells/batteries and depicts the determination of the impedances of a cell/battery and interconnecting conductor on a first end of the string in accordance with a particular aspect of the present invention.

FIG. 17b is a schematic representation of a parallel string of multiple cells/batteries and depicts the determination of the impedances of a cell/battery and interconnecting conductor on a second end of the string in accordance with a particular aspect of the present invention.

FIG. 18a is a schematic representation of a parallel string of multiple cells/batteries and depicts conditions of a first set of three-point measurements used in the determination of the impedances of an interior cell/battery and interconnecting conductor in accordance with a particular aspect of the present invention.

FIG. 18b is a schematic representation of a parallel string of multiple cells/batteries and depicts conditions of a second set of three-point measurements used in the determination of the impedances of an interior cell/battery and interconnecting conductor in accordance with a particular aspect of the present invention.

### DETAILED DESCRIPTION OF THE PREFERRED EMBODIMENTS

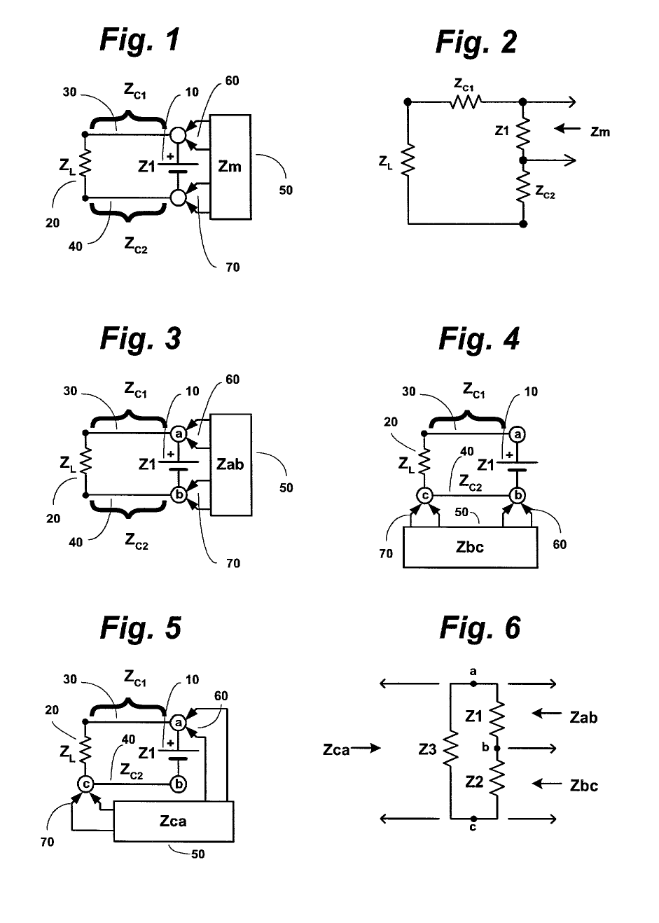

Consider FIG. 1. This figure illustrates measuring the impedance of cell/battery 10 embedded in a very simple battery system comprising cell/battery 10 connected to load 20 through interconnecting conductors 30 and 40. Impedances Z1, Z_{L}, Z_{C1}, and Z_{C2} represent the impedances of cell/battery 10, load 20, interconnecting conductor 30, and interconnecting conductor 40, respectively. Impedance meter 50, which may be of the type disclosed by Champlin in the patents and patent applications referenced above, contacts the two terminals of cell/battery 10 with Kelvin contacts 60 and Kelvin contacts 70. As is well known, Kelvin contacts comprise two separate electrical connections to each terminal—one for current and one for voltage—and negate the effects of contact and lead-wire resistance. Although Kelvin contacts are usually required to obtain accurate measurements with the very small impedance values encountered in most battery systems, the “three-point” measurement technique disclosed herein does not depend upon having Kelvin contacts. Single connections to each terminal will suffice if impedance values are sufficiently large.

FIG. 2 shows an equivalent circuit representation of the simple battery system of FIG. 1. Because the series combination of Z_{L}, Z_{C1}, and Z_{C2} parallels impedance Z1, the impedance Zm “seen” by impedance meter 50 is not actually Z1 but is instead the composite impedance:

$$Z m = \frac{Z1 \cdot ( {Z}_{C1} + {Z}_{C2} + {Z}_{L} )}{Z1 + {Z}_{C1} + {Z}_{C2} + {Z}_{L}} \qquad ( 1 )$$

The influence of the impedances Z_{C1}, Z_{C2}, and Z_{L} upon the measured impedance Zm is clearly observed in equation (1).

Now consider performing the three impedance measurements shown in FIGS. 3, 4, and 5.

First measure Zab (FIG. 3) with both sets of Kelvin contacts of impedance meter 50 directly contacting the two terminals, a and b, of the cell/battery being measured. Terminals a and b comprise the first two measuring points of a three-point measurement technique.

Next measure Zbc (FIG. 4) with one set of Kelvin contacts contacting one of the cell/battery's terminals, terminal b, and the other set bridging across the adjacent interconnecting conductor impedance Z_{C2}, to contact the load at point c. Point c comprises the third measuring point of the three-point measurement technique.

Finally, measure Zca (FIG. 5) with one set of Kelvin contacts contacting measuring point c and the other set contacting measuring point a.

FIG. 6 shows an equivalent circuit relating the three measured impedances Zab, Zbc, and Zca to the three system impedances Z1, Z2, and Z3. Note that this particular choice of measuring points makes system impedance Z2 equal the interconnecting conductance impedance Z_{C2} while system impedance Z3=Z_{L}+Z_{C1} combines the load impedance with the other interconnecting conductor impedance. An alternative choice of measuring points would make Z2=Z_{C1} and Z3=Z_{L}+Z_{C2}.

One can easily show from FIG. 6 that the three measured impedances are given by:

$$\begin{matrix}Z a b = \frac{Z1 \cdot ( Z2 + Z3 )}{Z1 + Z2 + Z3} & ( 2 ) \\ Z b c = \frac{Z2 \cdot ( Z3 + Z1 )}{Z1 + Z2 + Z3} \\ and & ( 3 ) \\ Z c a = \frac{Z3 \cdot ( Z1 + Z2 )}{Z1 + Z2 + Z3} & ( 4 )\end{matrix}$$

These three equations can be inverted mathematically to yield explicit expressions for Z1, Z2, and Z3, in terms of the measured quantities Zab, Zbc, and Zca. The results are

$$\begin{matrix}Z1 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z a b - Z b c - Z c a )} & ( 5 ) \\ Z2 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z b c - Z c a - Z a b )} & ( 6 )\end{matrix}$$

and

$$Z3 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z c a - Z a b - Z b c )} \qquad ( 7 )$$

Equation (5) effectively de-embeds the subject cell/battery since Z1 would be its measured impedance if it were, in fact, disconnected from the system.

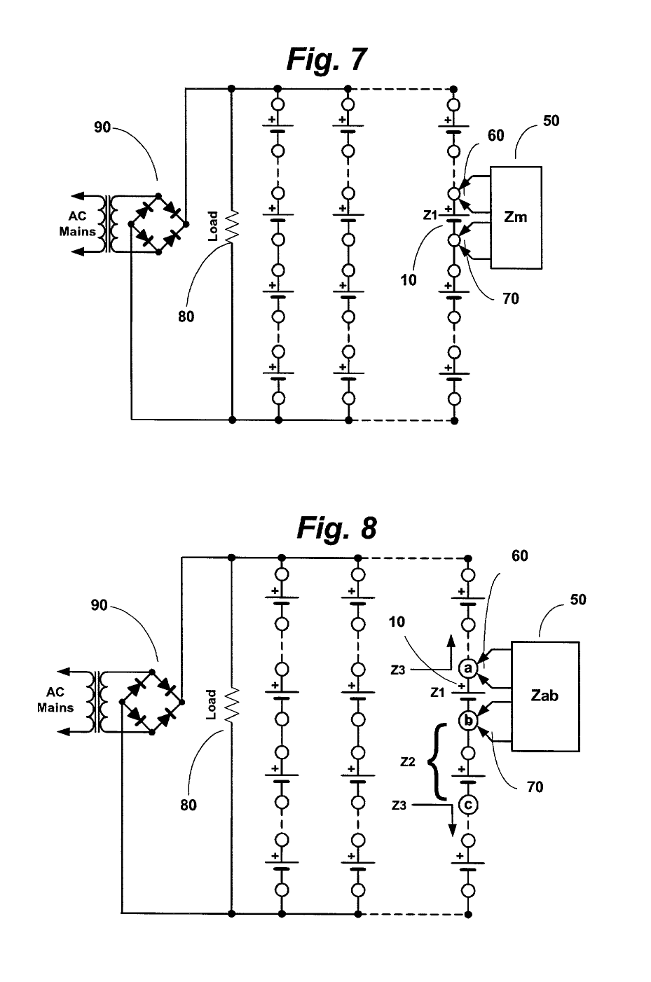

The three-point measurement technique disclosed above can be readily extended to the very important case depicted in FIG. 7. FIG. 7 illustrates an attempt to measure the impedance Z1 of cell/battery 10 embedded in a series string of cells/batteries, with a plurality of such strings arrayed in parallel. The parallel array may also include a load 80 and a rectifier 90 as shown. This arrangement is typical of battery/electrical systems routinely found in telephone central offices. Again, the loading of the system will interfere with the direct measurement of Z1 by impedance meter 50.

However, consider performing the three impedance measurements shown in FIGS. 8, 9, and 10.

First measure Zab (FIG. 8) with both sets of Kelvin contacts of impedance meter 50 directly contacting the two terminals, a and b, of the subject cell/battery. These two terminals comprise the first two measuring points of the three-point measurement technique.

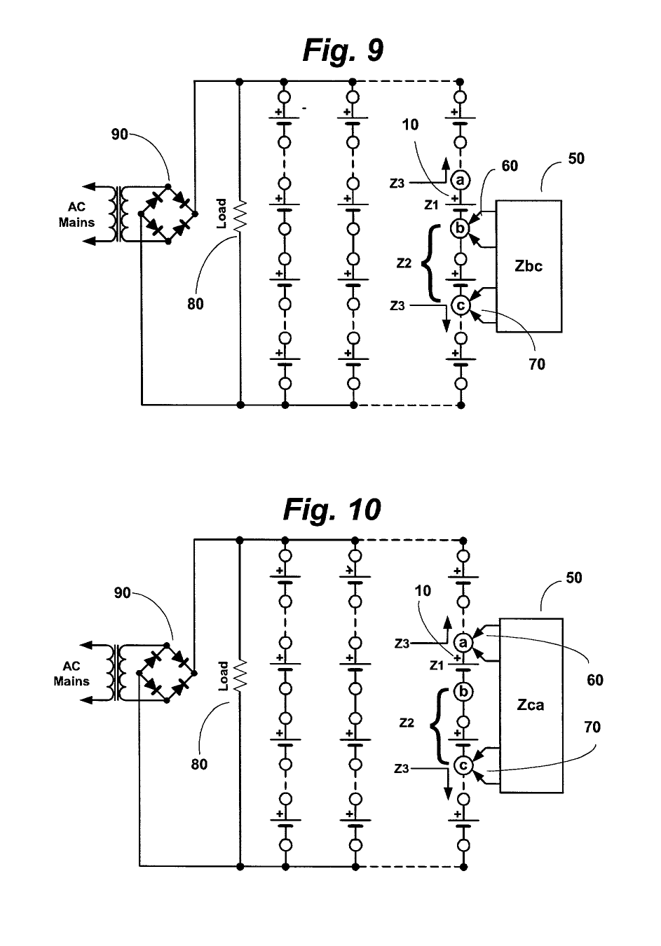

Next measure Zbc (FIG. 9) with one set of Kelvin contacts contacting one of the cell/battery's terminals, terminal b, and the other set bridging across an adjacent connector and an adjacent cell/battery to contact point C. Point c comprises the third measuring point of the three-point measurement technique.

Finally, measure Zca (FIG. 10) with one set of Kelvin contacts contacting measuring point c and the other set contacting measuring point a.

The experimental arrangements depicted in FIGS. 8, 9, and 10 have again divided the system into three impedances, Z1, Z2, and Z3. These three system impedances are identified in FIGS. 8, 9, and 10. System impedance Z1 is again the desired impedance of the subject cell/battery. System impedance Z2 is an arbitrarily-defined adjacent impedance which includes the impedance of both an adjacent cell/battery and an interconnecting conductor; and system impedance Z3 is the impedance of all of the rest of the battery system—not including system impedances Z1 and Z2.

The equivalent circuit of FIG. 6 again describes the relationships between system impedances Z1, Z2, Z3 and measured impedances Zab, Zbc, and Zca. Accordingly, equations (5)-(7) again explicitly yield Z1, Z2, and Z3. Impedance Z1 represents the de-embedded subject cell/battery and is of particular interest. The value of Z1 is again given by equation (5):

$$Z1 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z a b - Z b c - Z c a )} \qquad ( 5 )$$

In the example depicted above, the particular choice of measuring point c places both a cell/battery and an interconnecting conductor into impedance Z2. The measured value of Z2 is thus an arbitrary quantity that may be of little interest. However, one could just as well have chosen measuring point c so that impedance Z2 contains only the impedance of the adjacent interconnecting conductor. In that case, the interconnecting conductor impedance could be of considerable interest. Its value would be explicitly given by equation (6):

$$Z2 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z b c - Z c a - Z a b )} \qquad ( 6 )$$

Impedance Z3 describes the impedance of all of the rest of the battery system—not including impedances Z1 and Z2. Its value is explicitly given by equation (7):

$$Z3 = \frac{( Z a {b}^{2} + Z b {c}^{2} + Z c {a}^{2} - 2 \cdot Z b c \cdot Z c a - 2 \cdot Z c a \cdot Z a b - 2 \cdot Z a b \cdot Z b c )}{2 \cdot ( Z c a - Z a b - Z b c )} \qquad ( 7 )$$

In principle, these three measurements could be performed in sequence using conventional impedance measuring apparatus such as apparatus disclosed by Champlin in the U.S. patents and patent applications referred to above. Readings could be simply recorded after each measurement, and a hand calculator or computer subsequently employed to evaluate the appropriate equation or equations that de-embed the subject element or elements.

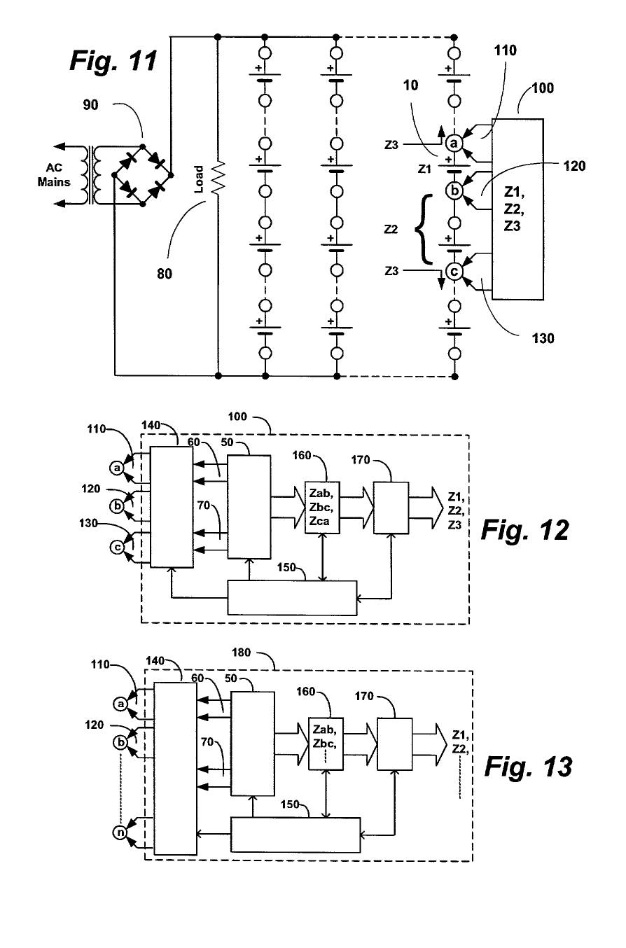

Alternatively, one could use a special three-point impedance meter 100 connected as shown in FIG. 11. One sees in FIG. 11 that three-point impedance meter 100 possesses three sets of system-contacting Kelvin conductors 110, 120, and 130 which simultaneously contact measuring points a, b, and c, respectively. FIG. 12 discloses further that three-point impedance meter 100 contains a conventional two-point impedance meter 50 adapted to measure the impedance of an isolated element connected between its Kelvin input conductors 60 and 70. Switching circuitry 140 is interposed between input conductors 60, 70 and system-contacting conductors 110, 120, 130, and is adapted to selectively connect a pair of system-contacting conductors (either 110 & 120, 120 & 130, or 130 & 110) to input conductors 60 & 70.

Under programmed control of microprocessor/controller 150, switching circuitry 140 alternately selects each particular pair of system-contacting conductors and commands impedance meter 50 to measure the impedance between its input conductors 60 and 70. The resulting three measured impedances are temporarily stored in storage memory 160 and then processed by computation circuitry 170—which may, in fact, also comprise microprocessor/controller 150—to determine the subject embedded impedance or impedances using one or more of equations (5),(6), and (7). Three-point impedance meter 100 therefore de-embeds the subject impedances directly, without operator intervention.

One could also construct measuring apparatus 180 (FIG. 13) which is similar to three-point impedance meter 100, but is extended to have an arbitrary number n of system-contacting conductors—where n is any integer between 3 and the number of interconnection points in the system. Under programmed control of microprocessor/controller 150, switching circuitry 140 alternately selects appropriate system-contacting conductors in groups of three. By consecutively performing three-point measurements upon each selected group, and evaluating one or more of equations (5), (6) and (7) after each set of three impedance measurements, extended apparatus 180 could potentially de-embed every element in the entire system without operator intervention.

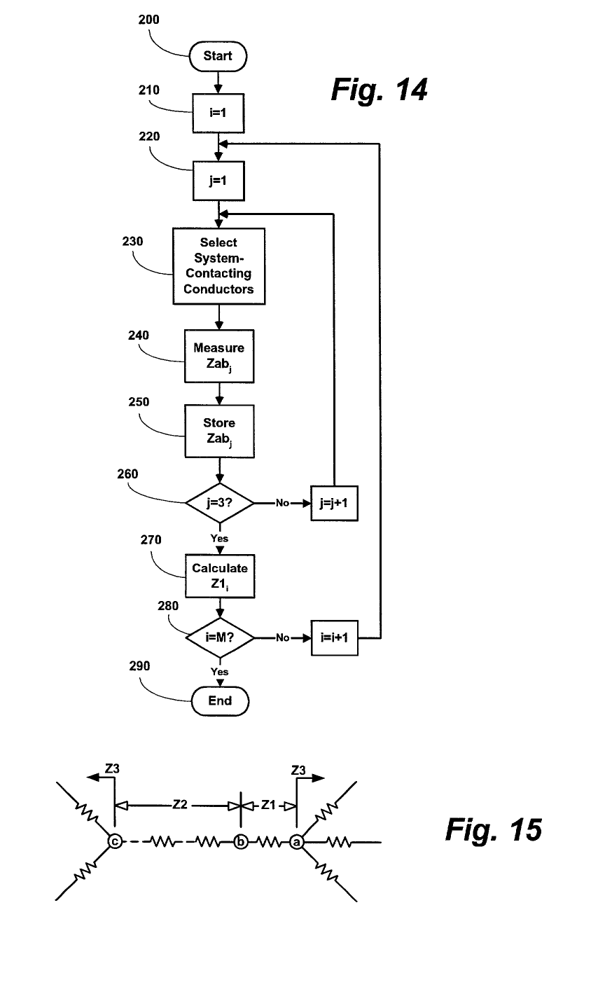

FIG. 14 discloses a flowchart of a control algorithm for de-embedding M single elements using the apparatus of FIG. 13. The algorithm begins at step 200. Step 210 initializes a measurement counter i, and step 220 initializes an element counter j. At step 230, a particular pair of system-contacting conductors is selected by switching circuitry 50. The corresponding impedance between these conductors is measured at step 240 and stored in memory 160 at step 250. At step 260, the measurement counter is tested. If it has not reached 3, the measurement counter is incremented and the measurements are repeated with a different pair of system-contacting conductors. If the measurement counter has reached 3, computation circuitry 170 calculates the impedance of one de-embedded element from the three measured impedances stored in memory 160 at step 270. The element counter is then tested at step 280. If it has not reached M, the element counter is incremented and the procedure is repeated to de-embed another element. However, if the element counter has reached M, all M elements have been de-embedded, and the procedure terminates at step 290.

One sees from the discussion regarding FIGS. 8, 9, and 10 that measuring point c can be chosen rather arbitrarily if one is only interested in the impedance of a single element, Z1. This single element could be either a cell/battery or an interconnecting conductor. If one desires to additionally measure the impedance of the nearest adjacent element (interconnecting conductor or cell/battery), the interval between b and c (i.e., impedance Z2) must contain only that one adjacent element.

The general rules to be followed in choosing measuring points can be understood with reference to FIG. 15. Measuring points a and b define the two terminals of a subject element whose impedance Z1 is desired to be measured. Furthermore, at least one of those two terminals must have no more than one conducting path proceeding from it. That single-path terminal is chosen as measuring point b. Measuring point c can then be any point along this single conducting path that can be reached without encountering an intervening branching path. There can be additional paths branching from point c itself; as there can also be from measuring point a. These two possibilities are illustrated in FIG. 12. However no paths can branch from point b or from any intermediate junction point between b and c.

If only the value of Z1 is desired, the number of cells/batteries and conductors disposed between measuring point b and measuring point c is unrestricted. However, as a result of the “no-branch” rule, an element on the end of a series string in a multi-string parallel array must have its measuring point c on the side of the element that is farthest from the parallel connection. An interior element of a series string, however, can have its measuring point c on either side.

An extension of this three-point measurement technique can be used to de-embed elements of parallel strings of batteries—such as are frequently employed in trucks and heavy equipment.

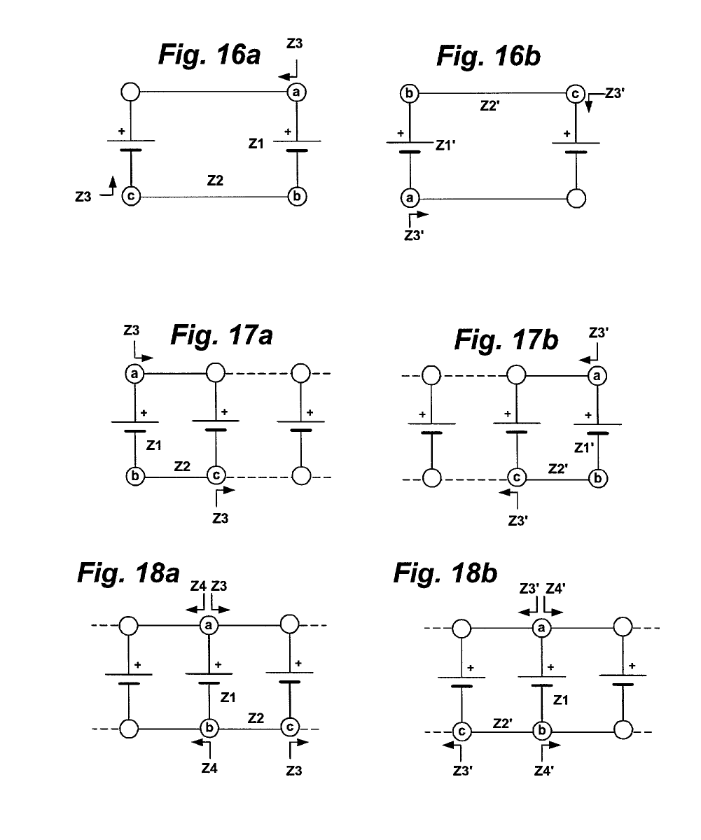

First, consider a simple system of two cells/batteries connected in parallel. FIG. 16a depicts such a system and identifies a choice of measuring points that simultaneously de-embeds the cell/battery on the right of FIG. 16a and the interconnecting conductor on the bottom. With the experimental arrangement shown, impedances Z1 and Z2 are given by equations (5) and (6), respectively. FIG. 16b shows a choice of measuring points that simultaneously de-embeds the other two elements. With the experimental arrangement shown in FIG. 16b, impedances Z1′ and Z2′ are given by equations (5) and (6), respectively. Thus, all four elements of this simple parallel system can be de-embedded with two sets of three-point measurements.

Multi-cell/battery parallel strings present a special challenge. Both terminals of a cell/battery in the interior of a parallel string have more than one conducting path leading from them. Accordingly, neither terminal satisfies the “no-branch rule” that must be satisfied by a measuring point b. However, the standard three-point measurement technique can still be applied to the interconnecting conductors and to the two cell/batteries on the ends of the string; and an extended form of the technique, a four-point, five-measurement, technique, can be applied to the cells/batteries in the interior.

First consider FIGS. 17a and 17b. These figures identify measuring points used to de-embed the cells/batteries and interconnecting conductors on the ends of a multi-element parallel string. With the experimental arrangements shown, cell/battery impedances Z1 and Z1′ are given by equation (5) and interconnecting conductor impedances Z2 and Z2′ are given by equation (6). By simply re-arranging the measuring points, the impedances of the other two interconnecting conductors at the ends of this string can be similarly determined.

Now consider FIGS. 18a and 18b. These figures depict two experimental three-point measurement sets performed on a cell/battery and its interconnecting conductors disposed in the interior of a parallel string. Note that measuring point c shifts from one side of the subject cell/battery to the other in the two experiments. However, Zab, the impedance measured between points a and b is the same in the two experiments. Thus, only five measurements are required to perform the two experiments.

Equation (6) yields the interconnecting conductor impedances Z2 and Z2′ in the two experiments. However, because measuring point b does not satisfy the “no-branch rule”, equation (5) does not yield Z1 directly in either experiment. Instead, equation (5) yields Z1 in parallel with Z4 in the first experiment and yields Z1 in parallel with Z4′ in the second experiment. However, Z4=Z2′+Z3′ is known from equations (6) and (7) of the second experiment, and Z4′=Z2+Z3 is known from equations (6) and (7) of the first experiment. Accordingly, by combining results of the two experiments, one can write the subject unknown cell/battery impedance Z1 as either

$$\begin{matrix}Z1 = \frac{M1 \cdot ( {Z2}^{′} + {Z3}^{′} )}{( {Z2}^{′} + {Z3}^{′} ) - M1} \\ o r & ( 8 ) \\ Z1 = \frac{{M1}^{′} \cdot ( Z2 + Z3 )}{( Z2 + Z3 ) - {M1}^{′}} & ( 9 )\end{matrix}$$

where M1, Z2,and Z3 are the results of evaluating equations (5), (6), and (7), respectively, in the first experiment, and M1′, Z2′, and Z3′ are the results of evaluating equations (5), (6), and (7), respectively, in the second experiment.

A special four-point impedance meter similar to three-point impedance meter 100 disclosed in FIG. 12, but having four sets of connections, could advantageously perform this four-point, five-measurement, procedure and de-embed the interior cell/battery without operator intervention.

For purposes of clarity, the above discussions have only considered measuring complex impedance Z. However, it will be apparent to workers skilled in the art that the disclosed measurement techniques apply equally well to measuring the reciprocal of complex impedance, complex admittance Y. Equations comparable to equation (5), (6), and (7) that give the unknown admittances Y1, Y2, and Y3 in terms of measured admittances Yab, Ybc, and Yac can be written

$$\begin{matrix}Y1 = \frac{2 YabYbcYca ( YbcYca - YabYbc - YcaYab )}{{Yab}^{2} {Ybc}^{2} + {Ybc}^{2} {Yca}^{2} + {Yca}^{2} {Yab}^{2} - 2 ( {Yab}^{2} YbcYca + {YabYbc}^{2} Yca + {YabYbcYca}^{2} )} & ( 10 ) \\ Y2 = \frac{2 YabYbcYca ( YcaYab - YbcYca - YabYbc )}{{Yab}^{2} {Ybc}^{2} + {Ybc}^{2} {Yca}^{2} + {Yca}^{2} {Yab}^{2} - 2 ( {Yab}^{2} YbcYca + {YabYbc}^{2} Yca + {YabYbcYca}^{2} )} \\ and & ( 11 ) \\ Y3 = \frac{2 YabYbcYca ( YabYbc - YcaYab - YbcYca )}{{Yab}^{2} {Ybc}^{2} + {Ybc}^{2} {Yca}^{2} + {Yca}^{2} {Yab}^{2} - 2 ( {Yab}^{2} YbcYca + {YabYbc}^{2} Yca + {YabYbcYca}^{2} )} & ( 12 )\end{matrix}$$

Furthermore, if reactive and susceptive effects can be ignored, the disclosed measuring techniques likewise apply to measuring real dynamic resistance R and real dynamic conductance G. Equations comparable to equation (5), (6), and (7) that give the unknown dynamic resistances R1, R2, and R3 in terms of measured dynamic resistances Rab, Rbc, and Rca are

$$\begin{matrix}R1 = \frac{( {Rab}^{2} + {Rbc}^{2} + {Rca}^{2} - 2 \cdot Rbc \cdot Rca - 2 \cdot Rca \cdot Rab - 2 \cdot Rab \cdot Rbc )}{2 \cdot ( Rab - Rbc - Rca )} & ( 13 ) \\ R2 = \frac{( {Rab}^{2} + {Rbc}^{2} + {Rca}^{2} - 2 \cdot Rbc \cdot Rca - 2 \cdot Rca \cdot Rab - 2 \cdot Rab \cdot Rbc )}{2 \cdot ( Rbc - Rca - Rab )} \\ and & ( 14 ) \\ R3 = \frac{( {Rab}^{2} + {Rbc}^{2} + {Rca}^{2} - 2 \cdot Rbc \cdot Rca - 2 \cdot Rca \cdot Rab - 2 \cdot Rab \cdot Rbc )}{2 \cdot ( Rca - Rab - Rbc )} & ( 15 )\end{matrix}$$

Similarly, equations comparable to equations (5), (6), and (7) that give the unknown dynamic conductances G1, G2, and G3 in terms of measured dynamic conductances, Gab, Gbc and Gca are

$$\begin{matrix}G1 = \frac{2 GabGbcGca ( GbcGca - GabGbc - GcaGab )}{\begin{matrix}{Gab}^{2} {Gbc}^{2} + {Gbc}^{2} {Gca}^{2} + {Gca}^{2} {Gab}^{2} - \\ 2 ( {Gab}^{2} GbcGca + {GabGbc}^{2} Gca + {GabGbcGca}^{2} )\end{matrix}} & ( 16 ) \\ G2 = \frac{2 GabGbcGca ( GcaGab - GbcGca - GabGbc )}{\begin{matrix}{Gab}^{2} {Gbc}^{2} + {Gbc}^{2} {Gca}^{2} + {Gca}^{2} {Gab}^{2} - \\ 2 ( {Gab}^{2} GbcGca + {GabGbc}^{2} Gca + {GabGbcGca}^{2} )\end{matrix}} and & ( 17 ) \\ G3 = \frac{2 GabGbcGca ( GabGbc - GcaGab - GbcGca )}{\begin{matrix}{Gab}^{2} {Gbc}^{2} + {Gbc}^{2} {Gca}^{2} + {Gca}^{2} {Gab}^{2} - \\ 2 - ( {Gab}^{2} GbcGca + {GabGbc}^{2} Gca + {GabGbcGca}^{2} )\end{matrix}} & ( 18 )\end{matrix}$$

Since all four quantities, Z, Y, R, and G are measured with time-varying signals, they are referred to collectively as “dynamic parameters”.

Although the present invention has been described with reference to preferred embodiments, workers skilled in the art will recognize that changes can be made in form and detail without departing from the true spirit and scope of the invention. For example, single conductor contacts rather than Kelvin contacts could be employed under appropriate circumstances. Three- and four-point testing could be performed using analog circuitry, digital circuitry, or hybrid combinations of analog and digital circuitry. The necessary calculations could be performed with a hand calculator, a computer, or an on-board processor. Measurements could be simply implemented with hand-held test equipment carried to a site. They could also be implemented with integrated measuring apparatus distributed throughout an entire battery system and configured to automatically de-embed and monitor various elements of the system. These and other variations of embodiments are believed to be well within the scope of the present invention and are intended to be covered by the appended claims.

What is claimed is:

1. Apparatus for evaluating a dynamic parameter of a particular element embedded in a system of interconnected electrochemical cells or batteries comprising:
dynamic parameter measuring circuitry adapted to contact first and second electrical contact points of said particular element and adapted to measure a first dynamic parameter between said first and second electrical contact points;
dynamic parameter measuring circuitry adapted to contact both said second electrical contact point and a third electrical contact point disposed on a conducting electrical path proceeding from said second electrical contact point and adapted to measure a second dynamic parameter between said second and third electrical contact points;
dynamic parameter measuring circuitry adapted to contact both said third electrical contact point and said first electrical contact point and adapted to measure a third dynamic parameter between said third and first electrical contact points;
computation circuitry adapted to compute said dynamic parameter of said particular element from measured values of said first, second, and third dynamic parameters.

2. Apparatus as in claim 1 wherein said dynamic parameter measuring circuitry contacts said first, second, and third electrical contact points with Kelvin contacts.

3. Apparatus as in claim 1 wherein said dynamic parameter is complex impedance.

4. Apparatus as in claim 1 wherein said dynamic parameter is complex admittance.

5. Apparatus as in claim 1 wherein said dynamic parameter is dynamic resistance.

6. Apparatus as in claim 1 wherein said dynamic parameter is dynamic conductance.

7. Apparatus as in claim 1 wherein said particular element is an electrochemical cell.

8. Apparatus as in claim 1 wherein said particular element is an electrochemical battery.

9. Apparatus as in claim 1 where said particular element is an interconnecting electrical conductor.

10. A method for evaluating a dynamic parameter of a particular element embedded in a system of interconnected electrochemical cells or batteries comprising:
measuring a first dynamic parameter between a first electrical contact point and a second electrical contact point of said particular element;
measuring a second dynamic parameter between said second electrical contact point and a third electrical contact point disposed on a conducting electrical path proceeding from said second electrical contact point;
measuring a third dynamic parameter between said third electrical contact point and said first electrical contact point; and
computing said dynamic parameter of said particular element from measured values of said first, second, and third dynamic parameters.

11. A method as in claim 10 wherein said dynamic parameter is complex impedance.

12. A method as in claim 10 wherein said dynamic parameter is complex admittance.

13. A method as in claim 10 wherein said dynamic parameter is dynamic resistance.

14. A method as in claim 10 wherein said dynamic parameter is dynamic conductance.

15. A method as in claim 10 wherein said particular element is an electrochemical cell.

16. A method as in claim 10 wherein said particular element is an electrochemical battery.

17. A method as in claim 10 wherein said particular element is an interconnecting electrical conductor.

18. A method as in claim 10 wherein said first, second, and third electrical contact points are contacted with Kelvin contacts.

19. A method for evaluating a dynamic parameter of a particular cell or battery embedded internally in an array of parallel-connected electrochemical cells or batteries comprising:
measuring a first dynamic parameter between first and second electrical contact points comprising terminals of said particular cell or battery;
measuring a second dynamic parameter between said second electrical contact point and a third electrical contact point disposed on a first conducting electrical path proceeding from said second electrical contact point;
measuring a third dynamic parameter between said second electrical contact point and a fourth electrical contact point disposed on a second conducting electrical path proceeding from said second electrical contact point;
measuring a fourth dynamic parameter between said third electrical contact point and said first electrical contact point;
measuring a fifth dynamic parameter between said fourth electrical contact point and said first electrical contact point; and
computing said dynamic parameter of said particular cell or battery from measured values of said first, second, third, fourth, and fifth dynamic parameters.

20. A method as in claim 19 wherein said dynamic parameter is complex impedance.

21. A method as in claim 19 wherein said dynamic parameter is complex admittance.

22. A method as in claim 19 wherein said dynamic parameter is dynamic resistance.

23. A method as in claim 19 wherein said dynamic parameter is dynamic conductance.

24. A method as in claim 19 wherein said first, second, third, an fourth electrical contact points are contacted with Kelvin contacts.

25. A method for evaluating a dynamic parameter of a particular interconnecting conductor embedded internally in an array of parallel-connected electrochemical cells or batteries comprising:
measuring a first dynamic parameter between first and second electrical contact points of said particular interconnecting conductor, said second electrical contact point comprising one terminal of a particular cell or battery of said array;
measuring a second dynamic parameter between said second electrical contact point and a third electrical contact point comprising a second terminal of said cell or battery;
measuring a third dynamic parameter between said third electrical contact point and said first electrical contact point; and
computing said dynamic parameter of said particular interconnecting conductor from measured values of said first, second, and third dynamic parameters.

26. A method as in claim 25 wherein said dynamic parameter is complex impedance.

27. A method as in claim 25 wherein said dynamic parameter is complex admittance.

28. A method as in claim 25 wherein said dynamic parameter is dynamic resistance.

29. A method as in claim 25 wherein said dynamic parameter is dynamic conductance.

30. A method as in claim 25 wherein said first, second, and third electrical contact points are contacted with Kelvin contacts.

31. Apparatus for evaluating dynamic parameters of first and second adjacent electrical elements having a common connecting point and embedded in a system of interconnected electrochemical cells or batteries comprising:
dynamic parameter measuring circuitry adapted to contact said first adjacent electrical element at both a first electrical contact point and at said common connecting point, and adapted to measure a first dynamic parameter between said first electrical contact point and said common connecting point;
dynamic parameter measuring circuitry adapted to contact said second adjacent electrical element at both a second electrical contact point and at said common connecting point, and adapted to measure a second dynamic parameter between said second electrical contact point and said common connecting point;
dynamic parameter measuring circuitry adapted to contact both said second electrical contact point and said first electrical contact point and adapted to measure a third dynamic parameter between said second electrical contact point and said first electrical contact point;
computation circuitry adapted to compute said dynamic parameters of said first and second adjacent electrical elements from measured values of said first, second, and third dynamic parameters.

32. Apparatus as in claim 31 wherein said dynamic parameter measuring circuitry contacts said first and second electrical contact points and said common connecting point with Kelvin contacts.

33. Apparatus as in claim 31 wherein said dynamic parameter is complex impedance.

34. Apparatus as in claim 31 wherein said dynamic parameter is complex admittance.

35. Apparatus as in claim 31 wherein said dynamic parameter is dynamic resistance.

36. Apparatus as in claim 31 wherein said dynamic parameter is dynamic conductance.

37. Apparatus as in claim 31 wherein said first and second adjacent electrical elements comprise an electrochemical cell and an interconnecting electrical conductor.

38. Apparatus as in claim 31 wherein said first and second adjacent electrical elements comprise an electrochemical battery and an interconnecting electrical conductor.

39. A method for evaluating dynamic parameters of first and second adjacent electrical elements having a common connecting point and embedded in a system of interconnected electrochemical cells or batteries comprising:
measuring a first dynamic parameter between said common connecting point and a first electrical contact point on said first adjacent electrical element;
measuring a second dynamic parameter between said common connecting point and a second electrical contact point on said second adjacent electrical element;
measuring a third dynamic parameter between said first electrical contact point and said second electrical contact point; and
computing said dynamic parameters of said first and second adjacent electrical elements from said first dynamic parameter, said second dynamic parameter, and said third dynamic parameter.

40. A method as in claim 39 wherein said first, second, and third dynamic parameters are measured with Kelvin contacts.

41. A method as in claim 39 wherein said dynamic parameter is complex impedance.

42. A method as in claim 39 wherein said dynamic parameter is complex admittance.

43. A method as in claim 39 wherein said dynamic parameter is dynamic resistance.

44. A method as in claim 39 wherein said dynamic parameter is dynamic conductance.

45. A method as in claim 39 wherein said first and second adjacent electrical elements comprise an electrochemical cell and an interconnecting electrical conductor.

46. A method as in claim 39 wherein said first and second adjacent electrical elements comprise an electrochemical battery and an interconnecting electrical conductor.

47. Apparatus for evaluating a dynamic parameter of a particular element embedded in a system of interconnected electrochemical cells or batteries adapted for performing the steps according to claim 10.

48. Apparatus for evaluating a dynamic parameter of a particular cell or battery embedded internally in an array of parallel-connected electrochemical cells or batteries adapted for performing the steps according to claim 19.

49. Apparatus for evaluating a dynamic parameter of a particular interconnecting conductor embedded internally in an array of parallel-connected electrochemical cells or batteries adapted for performing the steps according to claim 25.

50. Apparatus for evaluating dynamic parameters of first and second adjacent electrical elements having a common connecting point and embedded in a system of interconnected electrochemical cells or batteries adapted for performing the steps according to claim 39.

51. Apparatus for de-embedding dynamic parameters of electrical elements embedded in a system of electrochemical cells/batteries and conductors interconnected at m interconnection points comprising:
dynamic parameter measuring circuitry adapted to measure a dynamic parameter of an isolated element connected between its input conductors;
system-contacting conductors adapted to make electrical contacts to elements of said system at n interconnection points where n is an integer greater than two and less than m+1;
switching circuitry interposed between said system-contacting conductors and said input conductors and adapted to connect pairs of said system-contacting conductors to said input conductors;
control circuitry adapted to command said switching circuitry to selectively connect particular pairs of said system-contacting conductors to said input conductors and to command said dynamic parameter measuring circuitry to determine a measured dynamic parameter value with a said particular pair of said system-contacting conductors connected to said input conductors;
memory circuitry adapted to store each of said measured dynamic parameter values; and
computation circuitry adapted to compute one or more de-embedded dynamic parameters from said measured dynamic parameter values stored in said memory circuitry.

52. Apparatus as in claim 51 wherein n is equal to three.

53. Apparatus as in claim 51 wherein n is equal to four.

54. Apparatus as in claim 51 wherein n is equal to M.

55. Apparatus as in claim 51 wherein said input conductors are Kelvin input conductors, said system-contacting conductors are Kelvin system-contacting conductors, and said electrical contacts are Kelvin electrical contacts.

56. Apparatus as in claim 51 wherein said dynamic parameter is complex impedance.

57. Apparatus as in claim 51 wherein said dynamic parameter is complex admittance.

58. Apparatus as in claim 51 wherein said dynamic parameter is dynamic resistance.

59. Apparatus as in claim 51 wherein said dynamic parameter is dynamic conductance.

60. Apparatus as in claim 51 wherein said electrical elements are electrochemical cells.

61. Apparatus as in claim 51 wherein said electrical elements are electrochemical batteries.

62. Apparatus as in claim 51 wherein said electrical elements are electrical conductors.

63. Apparatus as in claim 51 wherein said computation circuitry computes a said de-embedded dynamic parameter from three said measured dynamic parameter values.

64. Apparatus as in claim 51 wherein said computation circuitry computes a said de-embedded dynamic parameter from five said measured dynamic parameter values.

65. Apparatus as in claim 51 wherein said control circuitry and said computation circuitry comprise a microprocessor or microcontroller.
